(19) United States
(12) Patent Application Publication
(10) Pub. No.: US 2024/0385801 A1
(43) Pub. Date: Nov. 21, 2024

(54) SIGNED EXTENSION CARRY-LOOK-AHEAD FOR ACCUMULATOR WITH BIT WIDTH DIFFERENCE

(71) Applicant: Taiwan Semiconductor Manufacturing Company, Ltd., Hsinchu (TW)

(72) Inventors: Haruki Mori, Hsinchu (TW); Hidehiro Fujiwara, Hsinchu (TW); Wei-Chang Zhao, Hsinchu (TW)

(73) Assignee: Taiwan Semiconductor Manufacturing Company, Ltd., Hsinchu (TW)

(21) Appl. No.: 18/467,977

(22) Filed: Sep. 15, 2023

Related U.S. Application Data
(60) Provisional application No. 63/503,040, filed on May 18, 2023.

(51) Int. Cl. G06F 7/507; G06F 5/01; G06F 7/501

(52) U.S. Cl. CPC G06F 7/507; G06F 5/01; G06F 7/501

(57) ABSTRACT

A device and method of operating the device are disclosed. In one aspect, a device includes receive a first bit of first input data and a plurality of second bits of second input data. The processing circuit generates a first output bit of output data based on the first bit of the first input data and a first bit of the plurality of second bits of the second input data. The processing circuit generates a second output bit of the output data based on the first bit of the first input data, the first bit of the plurality of second bits, and a second bit of the plurality of second bits of the second input data.

### CROSS-REFERENCE TO RELATED APPLICATION

This application claims the benefit of and priority to U.S. Provisional Application No. 63/503,040, filed May 18, 2023, which is incorporated herein by reference in its entirety.

### BACKGROUND

An integrated circuit (IC) can contain a variety of hardware circuit devices or types of logic, including FPGAs, application-specific integrated circuits (ASICs), logic gates, registers, or transistors, in addition to various interconnections between the circuit devices. The IC can be manufactured using or composed of semiconductor materials, for instance, as part of electronic devices, such as computers, portable devices, smartphones, internet of thing (IoT) devices, etc. Developments and increasing complexity of the ICs have prompted increased demands for higher computational efficiency and speed. More specifically, the ICs can be configurable and/or programmable to perform computations in sequences or variations desired by the manufacturer, developer, technician, or programmer, among others.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic block diagram of a 4-bit carry look-ahead (CLA) circuit for calculating carry outputs, in accordance with some embodiments of the present disclosure.

FIG. 2 illustrates an example logic circuit that implements a first 4-bit CLA circuit shown in FIG. 1 for least significant bits (LSB) and a second CLA circuit for most significant bits (MSB), in accordance with some embodiments of the present disclosure.

FIG. 3A illustrates a schematic block diagram of a 36-bit shifter and accumulator, which may be implemented as part of a digital compute-in-memory (DCIM) circuit, in accordance with some embodiments of the present disclosure.

FIG. 3B illustrates a detailed block diagram of the 36-bit accumulator shown in FIG. 3A, in accordance with some embodiments of the present disclosure.

FIG. 4A illustrates a schematic block diagram of an example adder tree that may implement a CLA circuit similar to those described herein, in accordance with some embodiments of the present disclosure.

FIG. 4B illustrates a diagram showing how the example CLA circuit shown in FIG. 4A computes sums from binary values having different bit widths, in accordance with some embodiments of the present disclosure.

FIG. 5 illustrates a schematic block diagram of an example DCIM circuit including a CLA circuit similar to those described herein, in accordance with some embodiments of the present disclosure.

FIG. 6 illustrates a flowchart of an example method to operate the disclosed CLA circuits described herein, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Digital compute-in-memory (DCIM) devices include circuits that combine memory and computation in the same physical location. By placing computational circuitry directly within memory storage circuits, data doesn't need to be transmitted as far to other processing circuits, which reduces computational latency and overall power consumption. Computational circuitry can include accumulator devices, which may include adder circuits and shifting circuits that efficiently process memory information for a variety of use-cases, including machine-learning, matrix multiplications, or general parallel computing.

DCIM devices may implement a variety of processing circuits, including accumulator circuits or adder circuits. Such adder circuits may include adder tree circuits that may implement binary addition or subtraction operations in a highly parallel manner. Adder trees typically include several parallel adder circuits implemented in a hierarchical structure, where the outputs of one level of adders serve as inputs to the next level, which may be followed by a final accumulator register that can implement addition or bit shifting operations.

One disadvantage of adder circuits is the propagation of carry values increase the overall latency of the circuit, which is particularly pronounced when using ripple carry adders with many adder stages. To ameliorate this delay, additional carry lookahead adder (CLA) circuits may be implemented that calculate the carry values in advance. However, conventional n-bit CLA circuits implement a large number of logic devices due to duplicated carry generation logic for both n-bit input operand data A and n-bit input operand data B. As the number of logic devices increases as the number of bits increases, the gate delay improvement is diminished due to the increased worse-case logical pathway length.

To address these issues, the systems and methods described herein leverage bit-width differences that occur in DCIM circuits and provide an improved CLA circuit that reduces overall logical device count and shortens the overall device latency. In DCIM circuits, a difference in bit-width between two added values may occur in a variety of circumstances, including in bit shifting accumulator operations or multi-bit support of weight values or input activations in machine learning applications. The systems and methods described herein can extend the sign of the shorter signed binary value to be added, and utilize the common sign value across multiple, parallel carry generation circuits to reduce logic device count and improve carry generation delay.

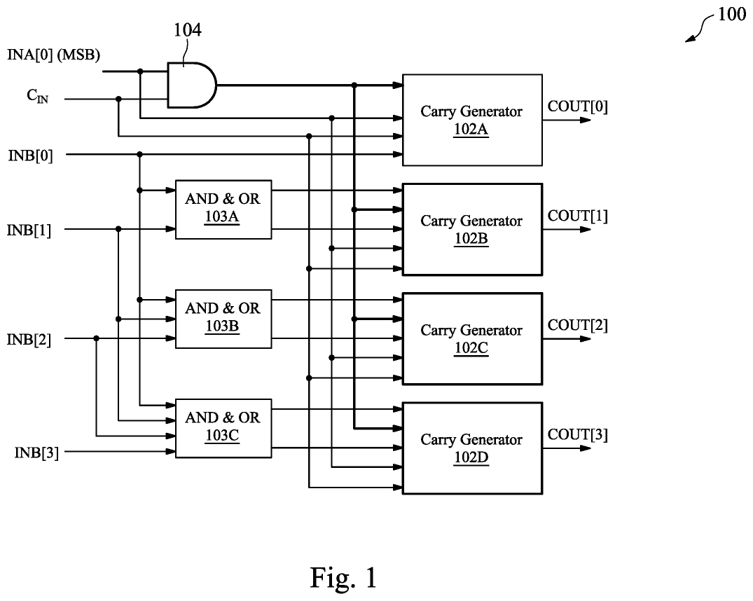

FIG. 1 illustrates a schematic block diagram of a 4-bit CLA system 100 for calculating carry outputs, in accordance with some embodiments of the present disclosure. A CLA circuit is a type of circuit that may be used in computer systems to generate carry values in parallel with the calculation of the sum between binary numbers. Each of the components shown in the CLA system 100 may receive power from one or more voltage sources. The CLA system 100 may include one or more logic gates and sub-circuits, each of which may be constructed from one or more logic gates. Logic gates are electronic devices that perform logical operations on one or more input signals to produce a single output signal.

Various embodiments of the circuits and logic gates that implement the CLA system 100 may include various transistors. The transistors described herein may have a certain type (n-type or p-type), but embodiments are not limited thereto. The transistors can be any suitable type of transistor including, but not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like.

As shown, the CLA system 100 includes an input logic gate 104 that receives the input signal INA[0] and the carry input Cᵢₙ. The input signal INA[0] is the most significant bit of the n-bit input data A, which as shown, is extended through each carry generator circuit 102A-102D. In this example, the input logic gate 104 is an AND gate that receives both the carry input Cᵢₙ and the input signal INA[0], and generates an enable signal that propagates to each of the carry generator circuits 102A-102D.

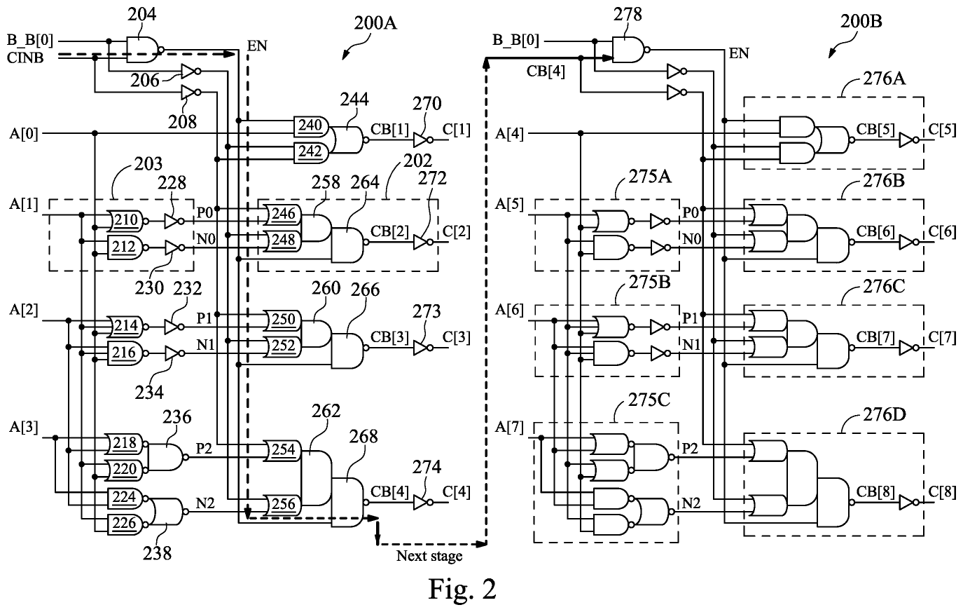

The 4-bit CLA system 100 receives four input bits from input data B, shown here as INB[0], INB[1], INB[2], and INB[3], each of which propagate through one or more components of the CLA system 100. As shown, the INB[0] input bit, which in this example is the least significant bit of the four-bit input data B, propagates directly to the carry generator 102A. The INB[0] input bit further propagates to each of the AND & OR logic circuits 103A, 103B, and 103C. Further details of the structure of the AND & OR logic circuits 103A, 103B, and 103C are described in connection with FIG. 2.

The AND & OR logic circuits 103A, 103B, and 103C each generate corresponding P and N intermediate values, which are provided to corresponding carry generators 102B, 102C, and 102D, respectively. In this example, the AND & OR logic circuit 103A receives the first two input bits of the input data B (the INB[0] bit and the INB[1] bit) as input, the AND & OR logic circuit 103B receives the first three input bits of the input data B (the INB[0] bit, the INB[1] bit, and the INB[2] bit) as input, and the AND & OR logic circuit 103C receives all four input bits of the input data B (the INB[0] bit, the INB[1] bit, the INB[2] bit, and the INB[3] bit) as input.

The carry generator circuits 102A, 102B, 102C, and 102D each generate a corresponding carry bit of output carry data, shown here as COUT[0], COUT[1], COUT[2], and COUT[3], each of which correspond to the carry bit for the respective input bits INB[0], INB[1], INB[2], and INB[3]. Further details of the structure of the AND & OR logic circuits 103A, 103B, and 103C are described in connection with FIG. 2. As shown, each of the carry generator circuits 102A-102D receive the enable signal produced by the logic gate 104 as input, as well as the most significant bit of the input data A (the INA[0] bit) and the carry input bit as input. Additionally, each of the carry generators 102B-102D receive corresponding P and N inputs from the AND & OR logic circuits 103A-103C as input.

Referring to FIG. 2, illustrated is an example logic circuit that includes a first 4-bit CLA circuit 200A or least significant bits of input data A and a second 4-bit CLA circuit 200B for the most significant bits of the input data A. The first and second CLA circuits 200A and 200B are shown as including one or more logic gates and sub-circuits, each of which may be constructed from one or more logic gates.

Various embodiments of the circuits and logic gates that implement the CLA system 100 may include various transistors. The transistors described herein may have a certain type (n-type or p-type), but embodiments are not limited thereto. The transistors can be any suitable type of transistor including, but not limited to, MOSFETs, CMOS transistors, PMOS, NMOS, BJTS, high voltage transistors, high frequency transistors, PFETs/NFETs, FinFETs, planar MOS transistors with raised source/drains, nanosheet FETs, nanowire FETs, or the like.

The 4-bit CLA circuit 200A includes a first CLA circuit 200A, which may be similar to the 4-bit CLA system 100 of FIG. 1. As shown, the first 4-bit CLA circuit 200A includes a NAND gate 204, which in this example implements the logic gate 104 of the 4-bit CLA circuit 200A. The NAND gate 204 receives the inverted carry input CINB and the inverted most significant bit of input data B (shown as B_B[0]) as input, and generates a corresponding EN signal that is propagated through various gates in the circuit 200A.

The inverted inputs B_B[0] and CINB are themselves inverted via the inverters 206 and 208 respectively, generating input signals B[0] and CIN having opposite (natural) logical states to B_B[0] and CINB. Each of these values are propagated to a respective carry generation circuit 202 to generate a corresponding carry output data. To generate the first carry bit C[1] of the carry output data, the B[0] and CIN signals are provided to the AND gates 240 and 242 as input. The AND gates 240 and 242, which provide their inputs to the NOR gate 244, collectively form a four input OR gate. As such, the inverse of the first carry output bit C[0], shown here as CB[1], is zero when the enable signal EN, the input bit B[0], the input carry bit CIN, and the least significant bit of the input data A, shown here as A[0], are logic low (sometimes referred to as logic zero). Otherwise, the first inverse carry bit CB[1] is logic low. The first inverse carry bit CB[1] is provided as input to the inverter 270 to generate the first carry output bit C[1].

As shown, compared to gates 240, 242, and 244 that generate the first carry output bit C[1], each of the carry output bits C[2], C[3], and C[4] utilize additional logic gates. Corresponding intermediate P and N signals are generated for each bit of input data A, which are provided as input into corresponding to carry generation logic circuits 202. The circuits that generate the intermediate P and N signals may be referred to herein as “NP cell(s) 203 or NP circuits 203” and may include an n-input OR gate logic equivalent and a corresponding n-input AND gate logic equivalent. Each NP cell 203 receives both its respective input bit and each previous input bit in the input data A. As shown, the first NP circuit 203 receives both the first input bit A[0] and the second input A[1] and input to a NOR gate 210 and a NAND gate 212. The AND and OR equivalent logic is completed using the inverters 228 and 230, respectively, to generate the intermediate P0 signal and the intermediate N0 signal, respectively.

In the example shown, the first NP circuit 203 (e.g., an implementation of the two-input the AND & OR circuit 103A of FIG. 1), two-input logic gates are utilized. Although logical inverse gates (e.g., NAND and NOR) with inverters are shown here, alternative logic gates may be utilized to achieve the logical equivalent of an OR operation between the input bits A[0] and A[1], and the logical equivalent of an AND operation between the input bits A[0] and A[1], to generate the P0 and N0 signals, respectively. The second NP circuit, with reference numeral omitted for visual clarity, receives the next input bit A[2], as well as the lesser input bits A[1] and A[0] in three-input logical OR and three-input logical AND equivalents to generate the intermediate P1 and N1 signals, respectively.

In this example, a three-input NOR gate 214 and a corresponding inverter 232 is used to achieve the three-input OR logical equivalent to generate the intermediate P1 signal, and a three-input NAND gate and a corresponding inverter 234 is used to achieve the three-input AND logical equivalent to generate the intermediate N1 signal. The third NP circuit, with reference numeral omitted for visual clarity, receives the next input bit A[3], as well as the lesser input bits A[2], A[1], and A[0] in four-input logical OR and three-input logical AND equivalents to generate the intermediate P1 and N1 signals, respectively.

In this example, the four-input logical equivalent OR is implemented using two two-input NOR gates 218 and 220, each of which provide an output to a two-input NAND gate 236. As shown, the NOR gate 218 receives the input bits A[2] and A[3] as input and provides a single output to the NAND gate 236. The NOR gate 220 receives the input bits A[0] and A[1] as input, and provides its own single output to the NAND gate 236. The NAND gate 236 outputs a logical equivalent to an OR operation between the input bits A[0], A[1], A[2], and A[3] as the intermediate P2 value.

In this example, the four-input logical equivalent AND is implemented using two two-input NAND gates 224 and 226, each of which provide an output to a two-input NOR gate 238. As shown, the NAND gate 224 receives the input bits A[2] and A[3] as input and provides a single output to the NOR gate 238. The NAND gate 226 receives the input bits A[0] and A[1] as input, and provides its own single output to the NOR gate 238. The NOR gate 238 outputs a logical equivalent to an OR operation between the input bits A[0], A[1], A[2], and A[3] as the intermediate P2 value. Each of the first NP circuit 203, the second NP circuit, and the third NP circuit shown in the first CLA circuit 200A may be implementations of the AND & OR circuits 103A, 103B, and 103C, respectively, shown in FIG. 1.

To generate the output carry bits C[2], C[3], and C[4], the intermediate P and N values generated by the NP circuits described herein can be provided as input to corresponding carry generation circuits, such as the illustrated first carry generation circuit 202. The first carry generation circuit 202 may be an implementation of the carry generator circuit 102B described in connection with FIG. 1. The first carry generation circuit 202 is shown as including a first OR gate 246, a second OR gate 248, an AND gate 258, a NAND gate 264, and an inverter 272. As shown, the first AND gate 246 receives the input carry bit CIN and the intermediate P0 signal as input, and provides an output to the AND gate 258. The second AND gate receives the most significant bit B[0] of the input data B and the intermediate N0 signal as input, and provides an output to the AND gate 258.

The AND gate 258 provides an output signal to the NAND gate 264. As shown, the NAND gate 264 also receives the enable signal EN as input. Using these two inputs, the NAND gate 264 generates an inverse of the carry output bit CB[2], which propagates through the inverter 272 to generate the second carry output bit C[2]. The logical output formula implemented by the carry generation circuit 202 is shown in the following equation:

$$\overline{C [ 2 ]} = \overline{( ( CIN + ( A [ 0 ] + A [ 0 ] ) ) \cdot ( B [ 0 ] + ( A [ 0 ] \cdot A [ 0 ] ) ) ) \cdot ( B [ 0 ] + CIN )}$$

where C̅[̅2̅]̅ is the inverted carry output CB[2], which is provided as input to the inverter 272 to generate the carry output bit C[2].

As shown, the second and third carry output generation circuits, which generate the carry output bits C[3] and C[4], have a structure that is similar to the first carry output generation circuit 202. The second carry generation circuit may be an implementation of the carry generator circuit 102C described in connection with FIG. 1. The second carry generation circuit is shown as including a first OR gate 250, a second OR gate 252, an AND gate 260, a NAND gate 266, and an inverter 273. As shown, the first AND gate 250 receives the input carry bit CIN and the intermediate P1 signal as input, and provides an output to the AND gate 260. The second AND gate receives the most significant bit B[0] of the input data B and the intermediate N1 signal as input, and provides an output to the AND gate 260.

The AND gate 260 provides an output signal to the NAND gate 266. As shown, the NAND gate 266 also receives the enable signal EN as input. Using these two inputs, the NAND gate 266 generates an inverse of the carry output bit CB[3], which propagates through the inverter 273 to generate the second carry output bit C[3]. The logical output formula implemented by the second carry generation circuit is shown in the following equation:

$$\overline{C [ 3 ]} = \overline{( ( CIN + ( A [ 0 ] + A [ 1 ] + A [ 2 ] ) ) \cdot ( B [ 0 ] + ( A [ 0 ] \cdot A [ 1 ] \cdot A [ 2 ] ) ) ) \cdot } \overline{( B [ 0 ] + C [ 0 ] )}$$

where C̅[̅3̅]̅ is the inverted carry output CB[3], which is provided as input to the inverter 273 to generate the carry output bit C[3].

The third carry generation circuit may be an implementation of the carry generator circuit 102D described in connection with FIG. 1. The third carry generation circuit is shown as including a first OR gate 254, a second OR gate 256, an AND gate 262, a NAND gate 268, and an inverter 274. As shown, the first AND gate 254 receives the input carry bit CIN and the intermediate P2 signal as input, and provides an output to the AND gate 262. The second AND gate receives the most significant bit B[0] of the input data B and the intermediate N2 signal as input, and provides an output to the AND gate 262.

The AND gate 262 provides an output signal to the NAND gate 268. The NAND gate 268 also receives the enable signal EN as input. Using these two inputs, the NAND gate 268 generates an inverse of the carry output bit CB[4], which propagates through the inverter 274 to generate the second carry output bit C[4]. The logical output formula implemented by the second carry generation circuit is shown in the following equation:

$$\overline{C [ 4 ]} = \overline{( ( CIN + ( A [ 0 ] + A [ 1 ] + A [ 2 ] + A [ 3 ] ) ) \cdot ( B [ 0 ] + ( A [ 0 ] \cdot A [ 1 ] \cdot A [ 2 ] \cdot A [ 3 ] ) ) ) \cdot } \overline{( B [ 0 ] + C [ 0 ] )}$$

where C̅[̅4̅]̅ is the inverted carry output CB[4], which is provided as input to the inverter 274 to generate the carry output bit C[4].

One advantage of the circuit 200A is the input carry bit CIN propagation delay through the circuit 200A is two gates from input to generate the inverse output carry CB[4]. Although the example circuit 200A is shown in FIG. 2 implements a 4-bit CLA, it should be understood that fewer, or additional, carry generation circuits and/or NP circuits can be added to generate additional carry bits. Further, in some implementations, and in the implementation shown here, multiple 4-bit CLA circuits may be implemented in a chain.

The 4-bit CLA circuit 200B, as shown, has a similar structure to the 4-bit CLA circuit 200A. For example, the CLA circuit 200B includes a first NP circuit 275A, a second NP circuit 275B, and a third NP circuit 275C, each of which generate corresponding intermediate P and N signals (e.g., P0, N0, P1, N1, P2, and N2), as described herein. Each of the intermediate P and N signals are provided to corresponding carry generation circuits 276B, 276C, and 276D, as shown, which are similar to the carry generation circuit 202 as described herein. In the configuration depicted in FIG. 2, the 4-bit CLA circuit 200B receives the next four bits of the input data A, shown here as the bits A[4], A[5], A[6], and A[7]. In addition, rather than receiving the carry input value, the circuit 200B receives the final inverse carry bit of the previous circuit in the chain, which in this configuration is the inverse carry bit CB[4].

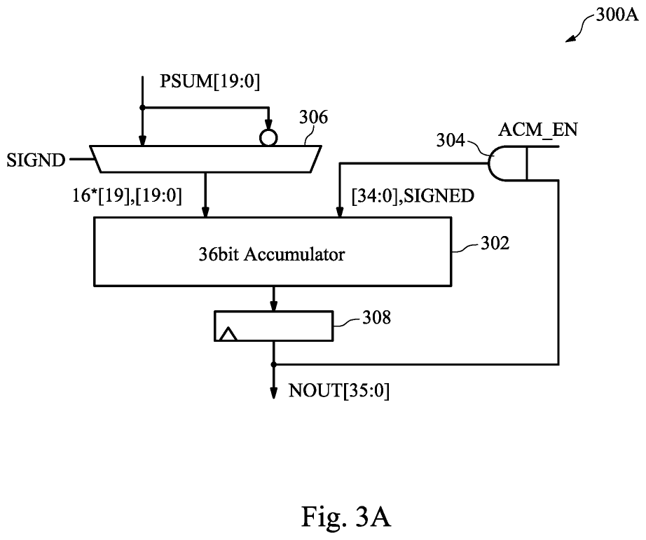

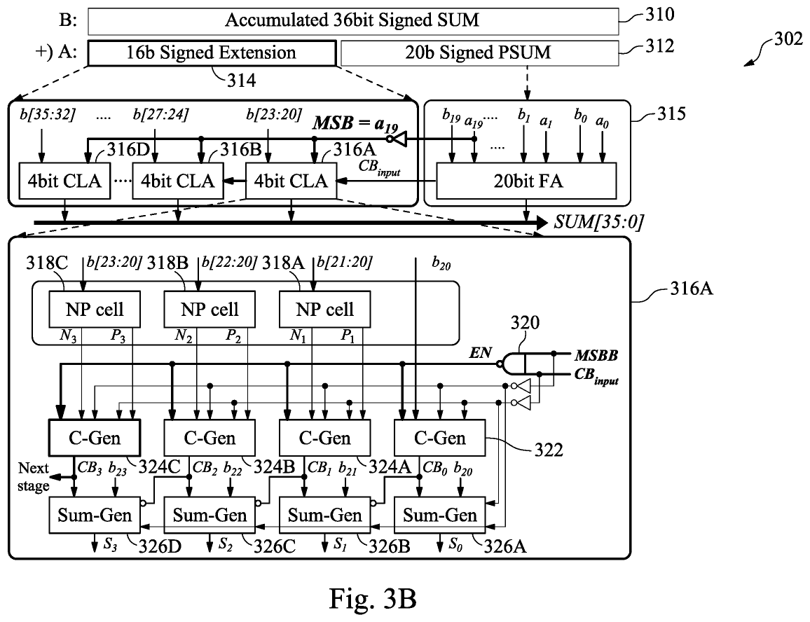

The circuit 200B is shown as including the NAND gate 278, which is similar to the NAND gate 204. The NAND gate 278 generates the enable signal EN for the circuit 200B based on the inverse carry bit CB[4] and the inverse of the most significant bit B[0] of the input data B. Similar advantages with respect to latency and device count are achieved through the use of the shared most significant bit B[0] of the input data B. The CLA circuits 200A and/or 200B can be utilized to implement a variety of different circuits, devices, and systems that add values with different bit widths. One example of such an adder is a 36-bit accumulator adder, such as that described in connection with FIGS. 3A and 3B.

Referring to FIG. 3A, illustrated is a schematic block diagram of a 36-bit shifter and accumulator 300A, which may be implemented as part of a DCIM circuit, in accordance with some embodiments of the present disclosure. As described herein, the CLA circuits may be implemented in any type of adder circuit in which values having different bit widths are summed. In this example, a 36-bit accumulator circuit 302 is implemented, which sums a 36-bit input data and 20 bit input data. The 20-bit input data may be a partial sum (shown as the PSUM[19:0], where[19:0] indicates a range of 20 bits from 19 to 0) generated from an adder tree circuit. As shown, a multiplexer 306 can receive the 20-bit partial sum and generate a 36-bit sign-extended value that includes both the lower 20-bits of the partial sum, with the sign bit of the partial sum extended to upper 16 bits of the resulting 36-bit word. The 36-bit sign-extended partial sum is provided as input to the 36-bit accumulator circuit 302.

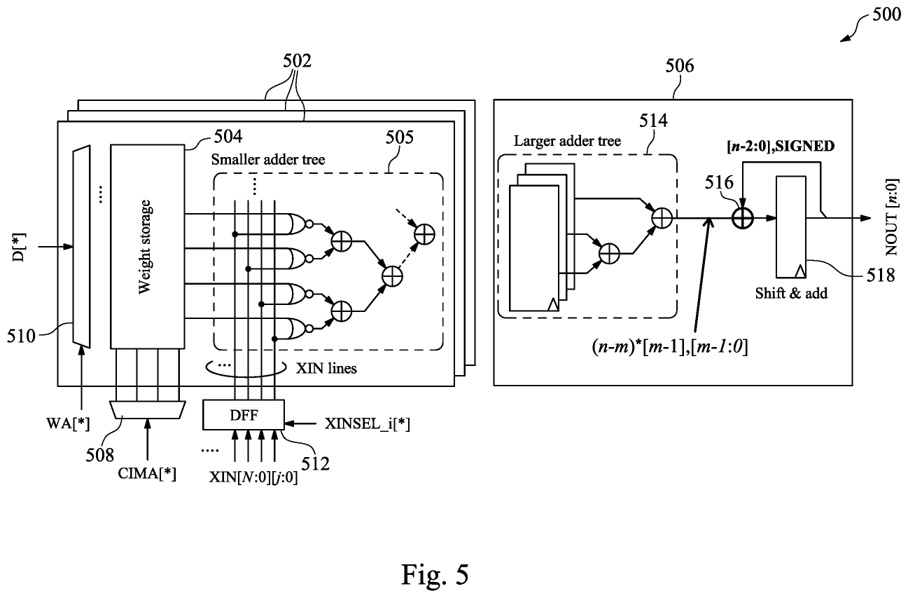

The second input of the accumulator circuit 302, in this example, is generated in part based on the output of the accumulator circuit 302. As shown, the accumulator circuit 302 provides an output to the shifting circuit 308 (which may be a bit-serial bit shifting operation implemented via flip-flops), which generates the 36-bit output NOUT. The 36-bit output NOUT is provided as input to the AND circuit 304, which provides the 36-bit output NOUT as the second input of the 36-bit accumulator 302 when the ACM_EN signal is active (e.g., logic high, logical one, etc.). The 36-bit shifter and accumulator circuit 300A may be utilized, for example, in a bit-serial DCIM circuit, as described in connection with FIG. 5. Further details of the operations of the 36-bit accumulator circuit 302 are described in connection with FIG. 3B.

Referring to FIG. 3B, illustrated is a detailed block diagram of the 36-bit accumulator 302 shown in FIG. 3A, in accordance with some embodiments of the present disclosure. The detailed block diagram shows how the input data B 310, which may be the NOUT of the accumulator 302, is summed with the 20-bit signed PSUM 312 (shown as input data A). As described in connection with FIG. 3A, the input data A has a 16-bit sign extension to, which as shown here is duplicated from the most significant bit of 20-bit signed sum 312 (shown as a₁₉).

To sum the input data A (the signed PSUM 312 and the 16-bit sign extension 314) and the input data B 310, the first 20 bits of the partial sum 312 of the input data A is summed with the corresponding first 20 bits of the signed input data B. The first 20 bits of the output SUM[35:0] can be calculated using a full adder circuit 315, which may be any type of adder circuit, for example, a ripple adder circuit. Then, as shown, the carry output (shown as _{CBinput}) generated by the adder circuit 315 is provided as input to the first 4-bit CLA circuit 316A. Each of the 4-bit CLA circuits 316A-316D (316C is omitted for visual clarity) may be similar to the 4-bit CLA circuit 200A of FIG. 2 or the 4-bit CLA system 100 of FIG. 1. The CLA circuits 316A-316D can be utilized to improve overall latency and reduce device count because the most significant sign bit (shown as a19) of the 20-bit signed PSUM 312 is shared between each 4-bit CLA circuit 316A-316D.

Each of the 4-bit CLA circuits 316A-316D receive a respect set of four bits of the input data B, with the first 4-bit CLA circuit 316A receiving the bits B[23:20], the second 4-bit CLA circuit 316B receiving the bits B[27:24], the third 4-bit CLA circuit (not shown for visual clarity) receiving the bits B[31:28], and the fourth 4-bit CLA circuit 316D receiving the bits B[35:32]. Each of the 4-bit CLA circuits 316A-316D can produce the corresponding four bits of the output SUM, with the first 4-bit CLA circuit 316A generating the output bits SUM[23:20], the second 4-bit CLA circuit 316B generating the output bits SUM[27:24], the third 4-bit CLA circuit generating the output bits SUM[31:28], and the fourth 4-bit CLA circuit 316D generating the output bits SUM[35:32].

Each of the 4-bit CLA circuits 316A-316D may include similar structure and functionality of the 4-bit CLA circuits described in connection with FIGS. 1 and 2. As shown, the carry output of each 4-bit CLA circuits is provided to the next 4-bit CLA circuit (e.g., the first 4-bit CLA circuit 316A provides the carry output CB₃ as input to the second 4-bit CLA circuit 316B, and so on). Further details of the first 4-bit CLA circuit 316A are shown here, but it should be understood that each of the other 4-bit CLA circuits 316B-316D include similar structure and perform similar operations using different input bits to produce their corresponding portions of the output SUM.

As shown, the 4-bit CLA circuit 316A includes the NP cells 318A-318C, which may be respectively similar to and include any of the structure and functionality of the AND & OR circuits 103A-103C of FIG. 1, respectively. As shown, each of the NP cells 318A-318C generate corresponding P and N signals, with the first NP cell 318A generating P₁ and N₁ signals (analogous to the P0 and N0 signals of FIG. 2), the second NP cell 318B generating P₂ and N₂ signals (analogous to the P1 and N1 signals of FIG. 2), and the third NP cell 318C generating P₃ and N₃ signals (analogous to the P2 and N2 signals of FIG. 2). As described herein, each of the NP cells 318A-318C receive bits from the input data, with each more-significant NP cell receiving an additional bit of the input data. As shown, the first NP cell 318A receives the first two bits B[21:20], the second NP cell 318C receives the first three bits B[22:20], and the third NP cell 318C receives the all four bits B[23:20] of the input data.

The 4-bit CLA circuit 316A is shown as including the logic gate 320, which is shown here as NAND gate that generates the enable signal EN, similar to the NAND gate 204 described in connection with FIG. 2 or the logic gate 104 described in connection with FIG. 1. The logic gate 320 receives the most significant bit of the input data A (a₁₉) and the carry input (produced by the adder circuit 315) as input to generate the enable signal EN, which is provided to an AND OR INVERT (AOI) circuit 322 and carry generation circuits 324A-324C. The AOI circuit 322 may include, for example, logic gates such as the AND gate 240, the AND gate 242, and the NOR gate 244 as described in connection with FIG. 2, and may include similar structure and functionality as those components described in connection with FIG. 2.

The AOI circuit 322 receives the enable signal EN, the vary input Cᵢₙₚᵤₜ (logically inverted from the illustrated (CBᵢₙₚᵤₜ), the most significant bit of the input data A (a₁₉ shown here

as logically inverted MSBB), and the least significant bit of input data B, shown as B[20], as input. The AOI circuit 322 generates the first carry output value CB₀, as described in connection with FIG. 1, which can be provided as input to a corresponding sum generation circuit 326A. The AOI circuit may include any combination of AND gates, OR gates, and/or inverters to achieve a logical equivalent to the outputs of the logic gates 240, 242, and 244 described in connection with FIG. 2.

The carry generation circuits 324A-324C may each be similar to, and include any of the same structure and perform the same functionality as, the carry generation circuits 102B-102D of FIG. 1, respectively, the carry generation circuit 202 of FIG. 2, and the carry generation circuits 276B-277D of FIG. 2, respectively. As described in connection with FIG. 2, each of the carry generation circuits 324A-324C receive corresponding P and N signals, with the first carry generation circuit 324A shown as receiving the P₁ and N₁ signals, the second carry generation circuit 324B shown as receiving the P₂ and N₂ signals, and the third carry generation circuit 324C shown as receiving the P₃ and N₃ signals. Additionally, each of the carry generation circuits 324A-324C receive the enable signal, the most significant bit of the input data A (a₁₉), and the carry input Cᵢₙₚᵤₜ. Each of the carry generation circuits 324A-324C generates a corresponding carry output value, shown here as the inverted carry outputs CB₁, CB₂, and CB₃, which are analogous to the inverted carry outputs CB[1], CB[2], and CB[3] of FIG. 2. Each of the carry generation circuits 324A-324C are shown as providing the corresponding inverted carry outputs to respectively to the sum generation circuits 326B-326D.

Each of the sum generation circuits 326A-326D can include an adder circuit that produces a respective sum value S₀, S₁, S₂, and S₃. As shown, each of the sum generation circuits 326A-326D receives the inverted carry output values (CB₀, CB₁, CB₂, CB₃, respectively) and a respective bit of the input data B (B₂₀, CB₂₁, B₂₂, B₂₃, respectively). Additionally, each of the generation circuits 326A-326D receives the carry output from the previous stage (e.g., the sum generation circuit 326B receiving the inverted carry output CB₀, and so on), with the first sum generation circuit 326A receiving Cᵢₙₚᵤₜ generated via the full adder 315. The sum generation circuits 326A-326D may include any combination of logic gates to generate a corresponding sum output bit Sₙ, where n is the corresponding sum index value. Each sum generation circuit 326A-326D can implement the following logic equation to generate a corresponding sum output bit:

$${S}_{n} = ( {B}_{m} \cdot {A}_{19} \cdot {C}_{n} ) + ( {B}_{n} + {A}_{19} + {C}_{n} ) \cdot \overline{{C}_{n} - 1}$$

where Bₘ is the corresponding input bit B₂₀, B₂₁, B₂₂, or B₂₃. Each of the corresponding sum bits can be provided as part of the output SUM.

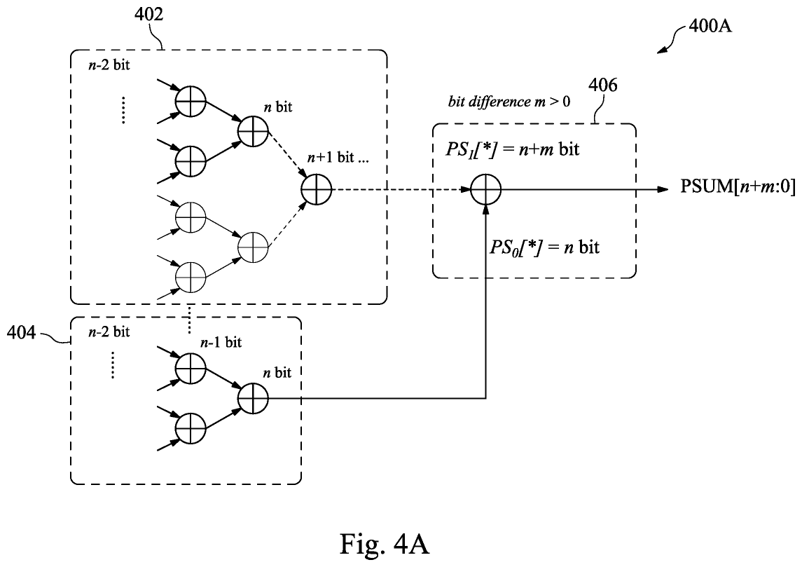

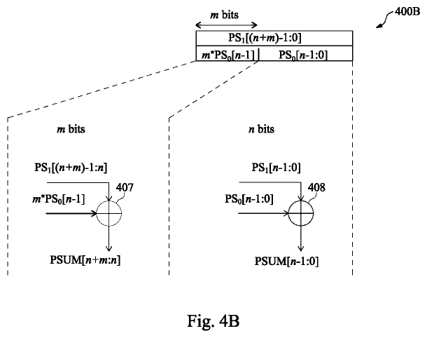

Referring to FIG. 4A, illustrated a schematic block diagram of an example adder tree 400A that may implement a CLA circuit like those described herein in connection with FIGS. 1-3B. As shown, the adder tree circuit 400A can include two separate adder trees 402 and 404 that produce partial sums having dissimilar bit widths. In this example, the second adder tree 404 produces a partial sum PS₀ having a bit width of n, and the first adder tree 402 produces a partial sum PS₁ having a bit width of n+m, making the bit width difference between the partial sum PS₀ and the partial sum PS₁ is m. Using an adder circuit similar to that shown in connection with FIG. 3, sign extension can be performed, and the CLA circuits described herein can be utilized to reduce device count and improve gate delay, to produce the output partial sum PSUM having a bit width of n+m. Further details of the sign extension and the sum process are described in connection with FIG. 4B.

Referring to FIG. 4B, illustrated is a diagram 400B showing how the example adder shown in FIG. 4A computes sums from values having different numbers of bits, in accordance with some embodiments of the present disclosure. As described in connection with FIG. 4A, the second partial sum PS₀ has a bit width of n, represented here as PS0[n−1:0], and the first partial sum PS₁ has a bit width of n+m. To compensate for this difference, the most significant bit (the sign bit) of the partial sum PS0 can be extended by m bits, as shown. Then, as shown, the lower n bits of the partial sums PS0 and PS1 may be added together using an adder circuit 408, which may be a ripple-carry adder, or any other type of full adder. To generate the upper bits of the PSUM output (shown as the PSUM[n+m:n], m bits of the sign extended partial sums PS0 (shown as m*PS0[n−1]) and the upper m bits of the partial sum PS1 (shown as PSUM[n+m:n]) can be added together using CLA adders similar to those described in connection with FIGS. 1, 2, 3A, and 3B. Similar techniques may be utilized to provide a

Referring to FIG. 5, illustrated is a schematic block diagram of an example DCIM circuit 500 including a CLA circuit 516 similar to those described herein in connection with FIGS. 1-4B. The DCIM circuit 500, in this example, include several, parallel, memory-compute circuits 502. Each memory-compute circuit 502 can include a memory circuit, which may include storage circuit 504 (e.g., SRAM, DRAM, flash memory, etc.). The storage circuit 504 may store any data that may be utilized in subsequent mathematical operations. In this example, the storage circuit 504 is shown as storing weight values, for example, for a machine-learning application.

The storage circuit 504 may be coupled to a write multiplexer 510, which can be utilized to select a write address to which the input data D[*] is to be written in the storage circuit 504. The storage circuit 504 may be coupled to a read multiplexer 508, which receives the CIMA[*] read selection signal that selects one or more addresses from which to read from the storage circuit 504. The bit values read from the storage circuit 504 can be provided as a first input to a first adder tree 505, which also receives a second input from the data input circuit 512. The data input circuit may include multiplexers and/or flip flips that can be provide a corresponding binary value (shown here as XIN lines) as input to the first adder tree 505. The XIN lines may be selected from the input data XIN[N:0][j:0] using the input data select signal XINSEL_i[*], as shown.

The first adder tree 505 may be used to perform the sum of multiple binary numbers in a parallel or pipelined manner. As shown, in this example, the first adder tree 505 perform several sums in parallel, and in a hierarchical manner, to produce a signal output partial sum for the respective memory-compute circuit 502. Each memory-compute circuit 502 may generate its own respective partial sum, each of which are then provided as input to the second adder tree 514, noted here as the “larger adder tree,” of the shift and accumulate circuit 506. The second adder tree 514 may include flip-flips, adder circuits, or other circuits that can sum the partial sum values receives from each of the memory-compute circuits 505. As shown, the shift and accumulate circuit 506 further includes a bit shifting circuit 518, which may implement a shift and add operation in conjunction with the CLA circuit 516. The CLA circuit 516 may be similar to, and include any of the structure and functionality of, the CLA circuits described in connection with FIGS. 1-4B.

In this example, an accumulator register included in the bit shifter circuit 518 may have a bit width that exceeds the output of the second adder tree 514. The difference in bit width enables the CLA circuit 516 to implement the sign-extension techniques described herein to perform carry-lookahead operations. As shown, the bit width of the output of the bit shifter circuit 518 is n, which includes one sign bit, while the output of the second adder tree is m, making the bit-width difference between the two binary values n−m. Using the techniques described in connection with FIGS. 1-4B, the CLA circuit 516 can include NP circuits, carry generation circuits, and sum generation circuits that can generate a sum for the upper n−m bits of the sign extended output of the second adder tree circuit 514 and the bit shifter 518. The output sum can be provided to and stored in the bit shifter circuit 518 for subsequent accumulations and output.

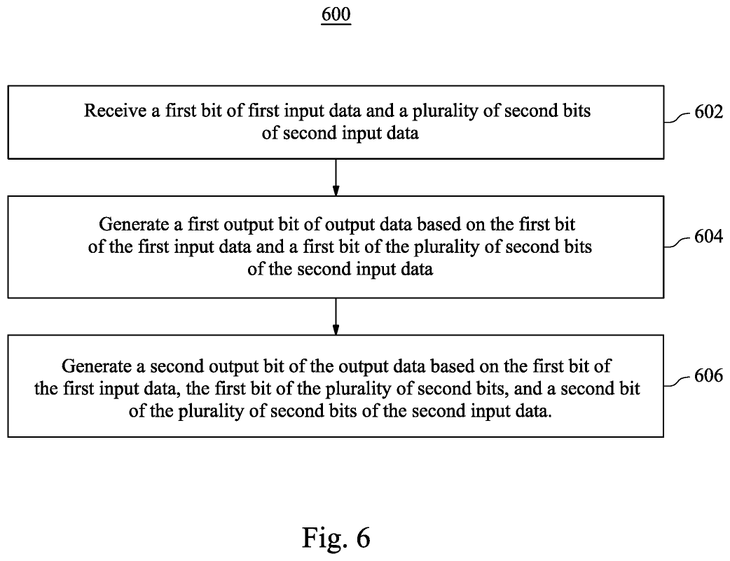

FIG. 6 illustrates a flowchart of an example method 600 to operate the disclosed CLA circuits, in accordance with some embodiments of the present disclosure. The method 600 may be used to operate an adder circuit, system, or device including CLA devices (e.g., the CLA system 100, the CLA circuit 200A, the CLA circuit 200B, the circuit 300A, the circuit 300B, the circuit 400A, the circuit 500, etc.), in which the binary values having different bit widths are added together. Accordingly, it is understood that additional operations may be provided before, during, and after the method 600 of FIG. 6, and that some other operations may only be briefly described herein.

In brief overview, the method 600 starts with operation 602 of the receiving a first bit of first input data (e.g., a most-significant sign bit of a smaller bit-width operand) and a plurality of second bits of second input data (e.g., the bits of a second operand). The method 600 proceeds with operation 604 of generating a first output bit of output data (e.g., a first carry output value) based on the first bit of the first input data and a first bit of the plurality of second bits of the second input data. The method 600 concludes with operation 606 of generating a second output bit (e.g., the second carry output value) of the output data based on the first bit of the first input data, the first bit of the plurality of second bits, and a second bit of the plurality of second bits of the second input data. The method 600 may be performed by a processing circuit.

Referring to operation 602, a first bit of first input data and a plurality of second bits of second input data are received by a processing circuit. The first input data and the second input data may be binary operands in a sum operation. The first input data may have a different bit width than the second input data. For example, the first input data may have a smaller bit width than the second output data. The first bit of the first input data and the plurality of second bits of the second input data may be received to perform a carry-lookahead operation. In addition to these values, the processing circuit may receive a carry input value as input, which may be received from another processing circuit (e.g., another carry-look ahead circuit, a full adder circuit, etc.).

Referring to operation 604, the processing circuit can generate a first output bit of output data based on the first bit of the first input data and a first bit of the plurality of second bits of the second input data. To do so, the processing circuit may provide the first bit of the first input data and the first bit of the second input data as input to an AOI circuit, which may include AND gates, OR gates, inverter gates, or logical inversions thereof (e.g., NAND, NOR, etc.) that generate the output carry bit. In some implementations, the AOI circuit may further receive and use the carry input bit to generate the first carry output. An enable signal, which may be generated according to the techniques described herein, may also be received by the AOI circuit to generate the first carry output. In some implementations, the first output bit may be a first carry output bit calculated according to the following equation:

$$\overline{C 1} = \overline{A 0 \cdot ( MSB + C 0 ) + ( MSB \cdot C 0 )}$$

where C̅1̅ is the first carry output bit, A0 is the first bit of the second input data, C0 is the carry input bit, and MSB is the first carry input bit of the first input data. The expression (MSB+C0) may be equivalent to the enable signal EN, as described herein.

Referring to operation 606, the processing circuit can generate a second output bit of the output data (e.g., the second carry output bit, such as the C[1] bit, the C[2] bit, the C[3] bit, etc.) based on the first bit of the first input data, the first bit of the plurality of second bits, and a second bit of the plurality of second bits of the second input data. To do so, the processing circuit may include an NP circuit, such as one of the NP cells 318A-318C, which generates P and N intermediate values as described in connection with FIG. 2. The intermediate values, in addition to the enable signal EN, the carry input signal, and the first bit of the first input data, can be provided as input to a carry generation circuit (e.g., the carry generation circuit 202, the carry generation circuit 324A, 324B, 324C, etc.) of the processing circuit. The carry generation circuit can generate the second output carry bit. As described herein, the output carry bits can be provided to respective adder circuits, such as the sum generation circuits 326A-326D of FIG. 3B.

In one aspect of the present disclosure, a device is disclosed. The device includes a processing circuit. The processing circuit can receive a first bit of first input data and a plurality of second bits of second input data. The processing circuit can generate a first output bit of output data based on the first bit of the first input data and a first bit of the plurality of second bits of the second input data. The processing circuit can generate a second output bit of the output data based on the first bit of the first input data, the first bit of the plurality of second bits, and a second bit of the plurality of second bits of the second input data.

In another aspect of the present disclosure, a system is disclosed. The system includes a first logic gate configured to generate an enable signal based on a first bit of first input data. The system includes a first circuit. The first circuit can receive a first bit and a second bit of second input data. The first circuit can generate a first intermediate signal and a second intermediate signal based on the first bit and the second bit of second input data. The system includes a second circuit. The second circuit can receive the enable signal, the first intermediate signal, and the second intermediate signal. The second circuit can generate a first output bit of output data based on the enable signal, the first intermediate signal, and the second intermediate signal.

In yet another aspect of the present disclosure, a method is disclosed. The method includes receiving, by a processing circuit, a first bit of first input data and a plurality of second bits of second input data. The method includes generating, by the processing circuit, a first output bit of output data based on the first bit of the first input data and a first bit of the plurality of second bits of the second input data. The method includes generating, by the processing circuit, a second output bit of the output data based on the first bit of the first input data, the first bit of the plurality of second bits, and a second bit of the plurality of second bits of the second input data.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A device, comprising:
a processing circuit configured to:
receive a first bit of first input data and a plurality of second bits of second input data;
generate a first output bit of output data based on the first bit of the first input data and a first bit of the plurality of second bits of the second input data; and
generate a second output bit of the output data based on the first bit of the first input data, the first bit of the plurality of second bits, and a second bit of the plurality of second bits of the second input data.

2. The device of claim 1, wherein the first bit of the first input data is a most significant bit (MSB) of the first input data.

3. The device of claim 1, wherein the processing circuit is further configured to provide the first output bit of the output data and the second output bit of the output data to a first adder circuit and a second adder circuit, respectively.

4. The device of claim 1, wherein the processing circuit is further configured to receive the second input data via a bit shift circuit.

5. The device of claim 1, wherein the processing circuit is further configured to:
receive a carry input; and
generate each of the first output bit and the second output bit of the output data further based on the carry input.

6. The device of claim 5, wherein the processing circuit is further configured to generate each of the first output bit and the second output bit of the output data further based on a NAND operation between the carry input and the first bit of the first input data.

7. The device of claim 1, wherein the first output bit is a first carry output and the second output bit is a second carry output of a sum between the first input data and the second input data.

8. The device of claim 7, wherein the processing circuit is further configured to generate the sum between the first input data and the second input data.

9. The device of claim 1, wherein the first input data comprises twenty bits and the second input data comprises thirty-six bits.

10. The device of claim 1, wherein the processing circuit is further configured to provide the second output data to a second processing circuit configured to generate a third output bit of the output data.

11. A system, comprising:
a first logic gate configured to generate an enable signal based on a first bit of first input data;
a first circuit configured to:
receive a first bit and a second bit of second input data; and
generate a first intermediate signal and a second intermediate signal based on the first bit and the second bit of second input data; and
a second circuit configured to:
receive the enable signal, the first intermediate signal, and the second intermediate signal; and
generate a first output bit of output data based on the enable signal, the first intermediate signal, and the second intermediate signal.

12. The system of claim 11, wherein the first bit of the first input data is a most significant bit (MSB) of the first input data.

13. The system of claim 11, further comprising a third circuit configured to generate a third intermediate signal and a fourth intermediate signal based on the first bit, the second bit, and a third bit of the second input data.

14. The system of claim 13, further comprising a fourth circuit configured to generate a second output bit of the output data based on the enable signal, the third intermediate signal, and the fourth intermediate signal.

15. The system of claim 14, wherein the fourth circuit is further configured to provide the second output bit of the output data to an adder circuit.

16. The system of claim 11, wherein the first circuit comprises a NAND gate and a NOR gate each receiving the first bit and the second bit of the second input data.

17. The system of claim 11, wherein the first bit of the first input data comprises a sign bit of the first input data.

18. A method, comprising:
receiving, by a processing circuit, a first bit of first input data and a plurality of second bits of second input data;
generating, by the processing circuit, a first output bit of output data based on the first bit of the first input data and a first bit of the plurality of second bits of the second input data; and
generating, by the processing circuit, a second output bit of the output data based on the first bit of the first input data, the first bit of the plurality of second bits, and a second bit of the plurality of second bits of the second input data.

19. The method of claim 18, further comprising providing, by the processing circuit, the first output bit of the output data and the second output bit of the output data to a first adder circuit and a second adder circuit, respectively.

20. The method of claim 18, further comprising:
receiving, by the processing circuit, a carry input; and
generating, by the processing circuit, each of the first output bit and the second output bit of the output data further based on the carry input.
